(19) United States
(12) Patent Application Publication
(10) Pub. No.: US 2009/0044499 A1
(43) Pub. Date: Feb. 19, 2009

(54) Riding stirrup

(76) Inventors: Sara Chambers, Paulden, AZ (US); Michael Chambers, Paulden, AZ (US)

Correspondence Address: GALLAGHER & KENNEDY, P. A., 2575 E. CAMELBACK RD. #1100, PHOENIX, AZ, 85016, US

(21) Appl. No.: 12/217,323

(22) Filed: Jul. 2, 2008

Related U.S. Application Data
(60) Provisional application No. 60/958,269, filed on Jul. 2, 2007.

(51) Int. Cl. B68C 3/00

(52) U.S. Cl. 54/49; 54/47

(57) ABSTRACT

There is provided a platform stirrup for supporting an equestrian rider's foot. The improved stirrup allows the rider to rest his weight on each foot by placing weight on both the heel of the foot and the ball of the foot. The stirrup still allows the rider to make good heel contact with the barrel of the horse. The platform stirrup includes a substantially planar platform defining an inner edge and an outer edge, a front edge and a rear edge, and the platform is shaped so as to accommodate the rider's foot. A forward arch extends from the inner edge of the platform in a substantially right angle; and a rear support extends from the rear edge of the platform in a substantially right angle. A forward strap is affixed to the inner forward arch; and a rear strap is affixed to the rear support or edge of the platform. The forward strap and the rear strap are also affixed to the saddle and the straps are configured so as to position the platform substantially parallel to the ground. A flexible shroud is affixed to the inner edge of the platform; and the flexible material allows the rider's heel to contact the barrel of the horse.

### CROSS REFERENCE TO RELATED APPLICATIONS

This application claims priority from the provisional patent application Ser. No. 60/958,269 filed Jul. 2, 2007 in the name of Sara Chambers and Michael Chambers, entitled “Riding Stirrup” incorporated herein by reference

### FIELD OF THE INVENTION

The present invention relates to equestrian equipment. More particularly, the invention relates to improvements in riding stirrups.

### BACKGROUND OF THE INVENTION

The art of horseback riding took a significant step forward when the common stirrup was invented. There are different theories as to when the stirrup was invented; however, it appears that it did enter European usage sometime after the period of the Roman Empire. The basic design of the stirrup has not significantly changed since that time. For example, the well known English riding stirrup, FIG. 1, is a loop-like structure with a bar on which the ball of the foot may rest. The Western style stirrup, FIG. 2, is similar in structure to the English stirrup in that it has a bar-like structure on which the rider places the ball, or perhaps the arch, of his foot. Stirrups commonly hang from the saddle by a belt of leather or synthetic material.

A variety of safety stirrups have also been developed. The safety stirrups generally provide different means by which to allow the rider's foot to break away if caught in the stirrup. However, during normal riding, the safety stirrups are designed to operate in a similar fashion to the English and Western stirrups; i.e., the rider significantly rests his or her weight in the stirrup on the ball of the foot.

The following is a quotation taken from the Wikipedia entry for the term “Stirrup” as found Jun. 21, 2007 on the website: www.wikipedia.org. The entry includes the following statement regarding problems with stirrup design:

“The stirrup design does have two inherent design flaws. The first is a safety issue: In stirrups with open fronts, it is possible for the rider's foot to slip through in whole or in part and cause the rider to be dragged in a fall. Modern English saddles are now designed with a stirrup bar that allows the stirrup leathers to fall from the saddle if the rider starts to be dragged. Some English stirrups are also designed with breakaway sides. Western saddles have somewhat wider stirrups to minimize this risk. Sometimes, they are also equipped with tapaderos, leather covers over the toe that close each stirrup from the front. A tapadero prevents the rider's boot from slipping through and also prevents brush encountered while working cattle on the open range from poking through the stirrup, injuring or impeding the horse or rider.”

“Proper stirrup placement, on the ball of the foot, instead of jammed “home” clear up to the arch, also lowers the risk of a rider being dragged if he or she happens to fall from the horse.”

“The second design flaw of the stirrup has potential negative impact on the health of the human foot. The rider's whole weight is at times supported entirely by the stirrups. During these periods, excessive pressure can be exerted on the Peroneus Tertius tendon which runs along the bottom of the foot. In extreme cases, stirrups have been found to cause damage to the tuberosity of the 5th metatarsal bone. Over long periods of extreme use, this can cause various medical conditions ranging from simple impaired walking to severe pronation or supination of the foot. Normal riders, however, generally have no related problems, even over a lifetime of riding. Disciplines that require long hours in the saddle, such as endurance riding and some types of western riding on a working ranch, often use a wider stirrup to provide more support to the foot.”

Thus, in spite of wide usage, and in spite of development over many centuries, there remains an ongoing need to overcome deficiencies in current stirrup design.

One reason the stirrup has persisted in its current design relates to the rider's need for interaction with and control of the horse. In current practice the rider's heels make contact with the sensitive barrel of the horse. By lightly touching or applying pressure from the rider's heel to the horse, the rider can signal the horse for a desired movement. Some riders make use of spurs strapped to the foot so as to allow a method of direct and clear physical communication between horse and rider. The prior art stirrup design allows the rider's heel to make free contact with the horse's barrel in that only the ball of the foot rests on the stirrup and the heel is free to pivot against the horse. It would be desired that an improved stirrup design continue to allow the rider to make heel contact with the horse.

In addition to the above points, current stirrup designs can lead to difficulties for young or beginning riders. The beginning rider must learn how to balance his or her weight (or at least a part of the rider's weight) in the stirrup while the horse goes through the various movements such as walking, trotting, cantering, galloping, and jumping. It can be one of the more difficult skills for a rider to develop. It would be desired to provide an improved stirrup in order for a novice rider to more quickly gain confidence and skill in the saddle. Older riders too may begin to suffer from a poor or deteriorating balance with age and may benefit from an improved stirrup design; and relatedly an improved stirrup design can prolong the riding ability of older riders. Riders with impaired balance due to physical limitations or disabilities may also benefit from an improved stirrup design.

Wholly separate from the equestrian arts, there has developed a knowledge of the human body, its balance, and its function through practices such as yoga. Static and dynamic movements in yoga teach the practitioner an awareness of the individual's balance and stability. Yoga further teaches the practitioner how to best position the body for optimum muscular and skeletal support. For example, in the yoga move known as the “Mountain Pose” the practitioner learns that the entire supporting surface of the foot, the ball and the heel of the foot, can provide support to the weight of the remainder of the body. Additionally, the yoga practitioner learns that the body's weight can be strongly supported when that weight rests over the heel portion of the foot. In biomechanics, this region of the foot may be known as a “control center” for proper foot balance; see e.g., http://www.biomech.com/db_area/archives/11996/9611 custom.bio.html. It would be desired to develop an improved stirrup design that incorporates at least some of the stability and balance that can be achieved through yoga. Further it would be desired to incorporate the knowledge of balance and stability learned through yoga and related biomechanics into contemporary stirrup designs.

Hence there has been identified a need to provide an improved riding stirrup. It is desired that an improved riding stirrup provide improved balance, feel, and support to the horse rider. It is further desired that an improved riding stirrup provide for a safe manner of usage in such manner as to minimize the risk of the foot becoming entangled in the stirrup. It is further desired that an improved riding stirrup allow for good contact between the rider's heel and the barrel of the horse. Additionally, it is desired that an improved stirrup allow a novice rider to quickly develop skills with the stirrup. The present invention addresses one or more of these needs.

### SUMMARY OF THE INVENTION

One of the current inventors is a practitioner of both yoga and the equestrian arts. In a wholly unexpected discovery, involving a combination of knowledge and experience from these two separate and unrelated arts, the inventor has found that yoga-based balancing techniques can be used as a basis from which to design an improvement of the ordinary stirrup. A new and improved kind of stirrup provides for support of the full foot surface, not just the ball, toes, or arch of the foot. In this manner the rider achieves an increased stability and balance in the saddle, which in turn leads to an increased confidence and quick learning curve for new or young riders.

In accordance with one aspect of the present invention, and by way of example only, there is provided a platform stirrup for supporting an equestrian rider's foot. The improved stirrup allows the rider to rest (or partially rest) his weight on each foot by placing weight on both the heel of the foot and the ball of the foot. The stirrup still allows the rider to make good heel contact with the barrel of the horse. The platform stirrup includes a substantially planar platform defining an inner edge and an outer edge, a front edge and a rear edge, and the platform is shaped so as to accommodate the rider's foot. A front arch may extend from the inner edge of the platform in a substantially right angle to the inner edge of the platform. A rear support may extend from the rear edge of the platform in a substantially right angle. A forward strap is affixed to the front arch; and a rear strap is affixed to the rear support. The forward strap and the rear strap are also affixed to the saddle and the straps are configured so as to position the platform substantially parallel to the ground. A flexible shroud is affixed to the inner edge of the platform; and the flexible material allows the rider's heel to contact the barrel of the horse.

In another aspect of the present invention, still by way of example only, there is provided a method for supporting an equestrian rider in a saddle comprising the steps of hanging a first platform stirrup from the left side of a horse; hanging a second platform stirrup from the right side of a horse; placing the rider's left foot on the first platform stirrup such that both the ball and heel of the rider's left foot contact the platform; and placing the rider's right foot on the second platform stirrup such that both the ball and heel of the rider's right foot contact the platform. The method may also include the steps of: supporting the first platform stirrup with a forward strap connected to the saddle; supporting the first platform stirrup with a rear strap connected to the saddle; supporting the second platform stirrup with a forward strap connected to the saddle; and supporting the second platform stirrup with a rear strap connected to the saddle. In the practice of this method, wherein the rider has a left foot and a right foot that each includes a ball and a heel (or a prosthesis simulating a foot) and the rider has a weight, the rider's weight is substantially supported on the right heel resting on the second platform and the rider's weight is also substantially supported on the left heel resting on the first platform. Alternatively, the rider's weight is supported by both the heel and the ball of the right foot (or prosthesis) resting on the second platform and by both the heel and the ball of the left foot resting on the first platform.

Other independent features and advantages of the improved riding stirrup will become apparent from the following detailed description, taken in conjunction with the accompanying drawings which illustrate, by way of example, the principles of the invention.

### BRIEF DESCRIPTION OF THE DRAWINGS

FIG. 1 is representation of a prior art English-style stirrup;

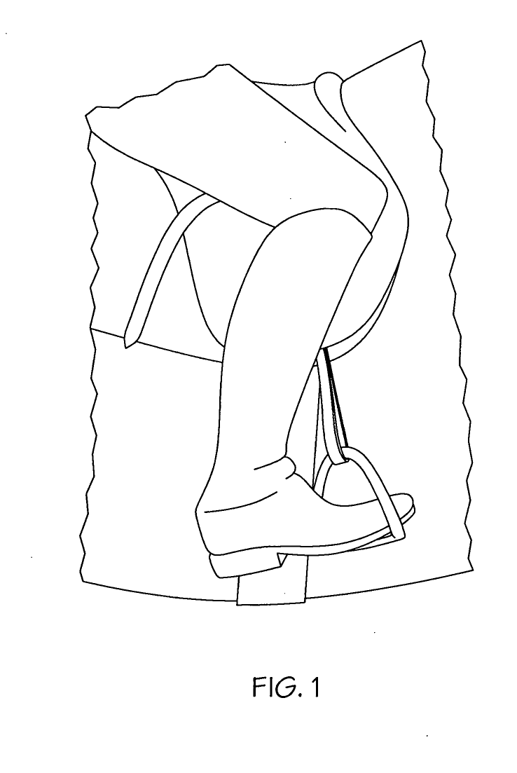

FIG. 2 is a representation of a prior art Western-style stirrup;

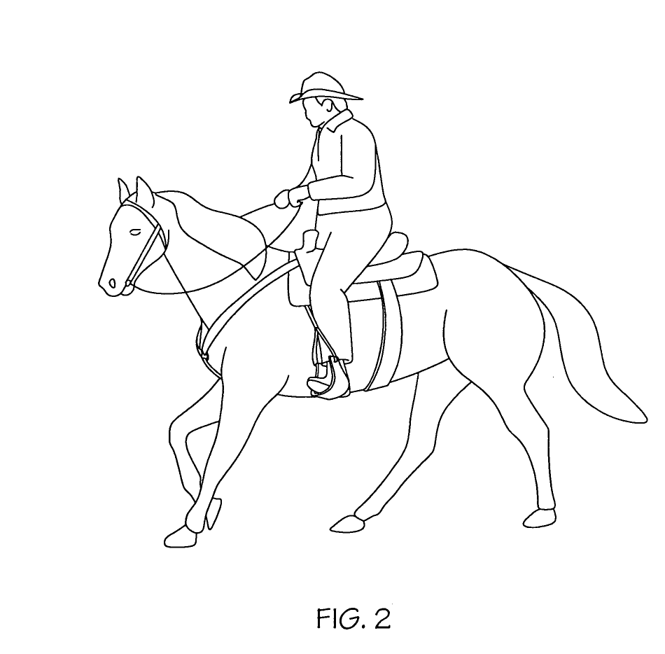

FIG. 3 is a perspective view of an improved stirrup, according to an embodiment of the present invention;

FIG. 4 is a further perspective view of an improved riding stirrup suspended from a saddle, with shroud, according to an embodiment of the present invention; and

FIG. 5 is a flow chart showing steps in a method of using an improved riding stirrup, according to an embodiment of the present invention.

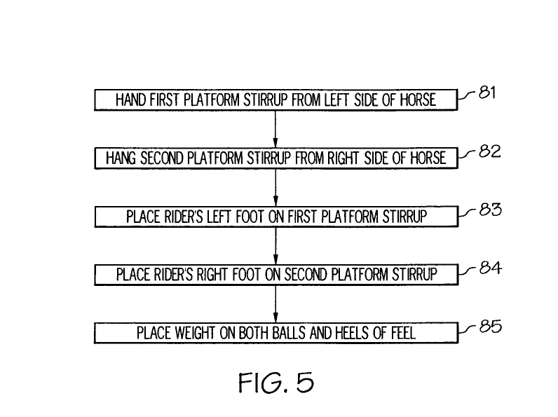

### LIST OF REFERENCE NUMERALS

Wherever possible, the same reference numbers will be used throughout the drawings to refer to the same or like parts. A partial listing of these reference numbers is as follows:
10 stirrup
12 platform
14 forward arch
15 rear support
17 saddle
21 inner edge
22 outer edge
23 forward edge
24 rear edge
25 length
26 width
42 forward strap
43 rear strap
61 shroud
27 Front foot guard
28 Heel recess
29 Toe ramp

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings.

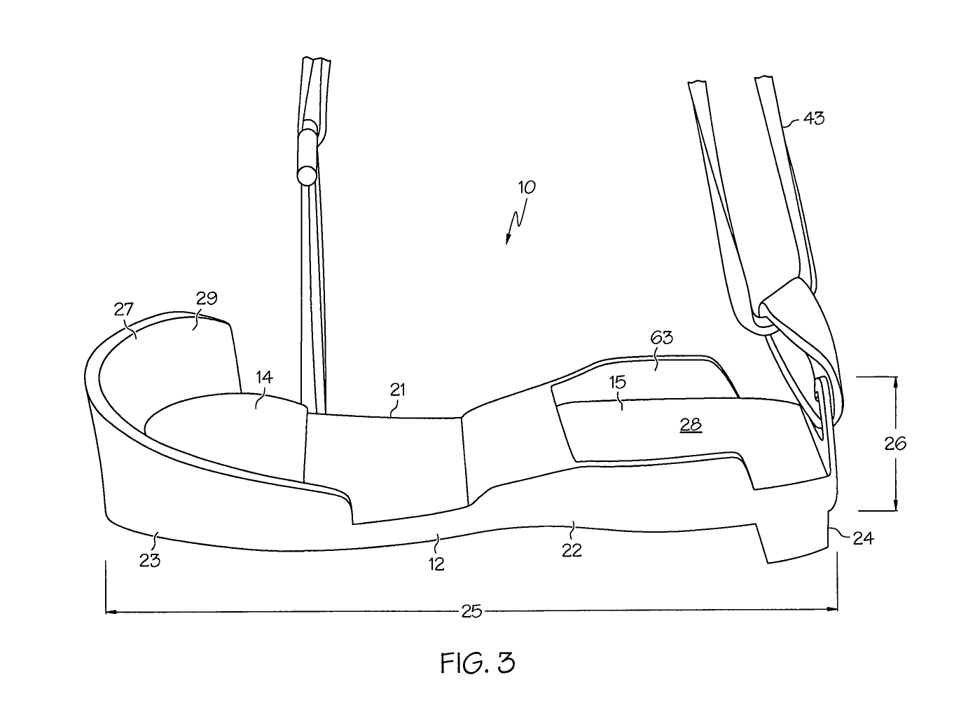

Referring to FIG. 3 there is shown a preferred embodiment of an improved riding stirrup. Stirrup 10 includes platform 12, forward arch 14, rear support 15, and shroud 61. Platform 12 has an inner edge 21, outer edge 22, forward edge 23, and rear edge 24. Forward arch 14 is connected to platform 12 at forward inner edge 21 (best shown in FIG. 3). Shroud 61 is preferably connected to platform 12 at inner edge 21. Other stirrup embodiments may include a front foot guard 27. Platform 12 may have a heel recess 28 and a toe ramp 29. Forward strap 42 connects stirrup 10 to saddle 17. Rear strap 43, if present, also supports stirrup 10.

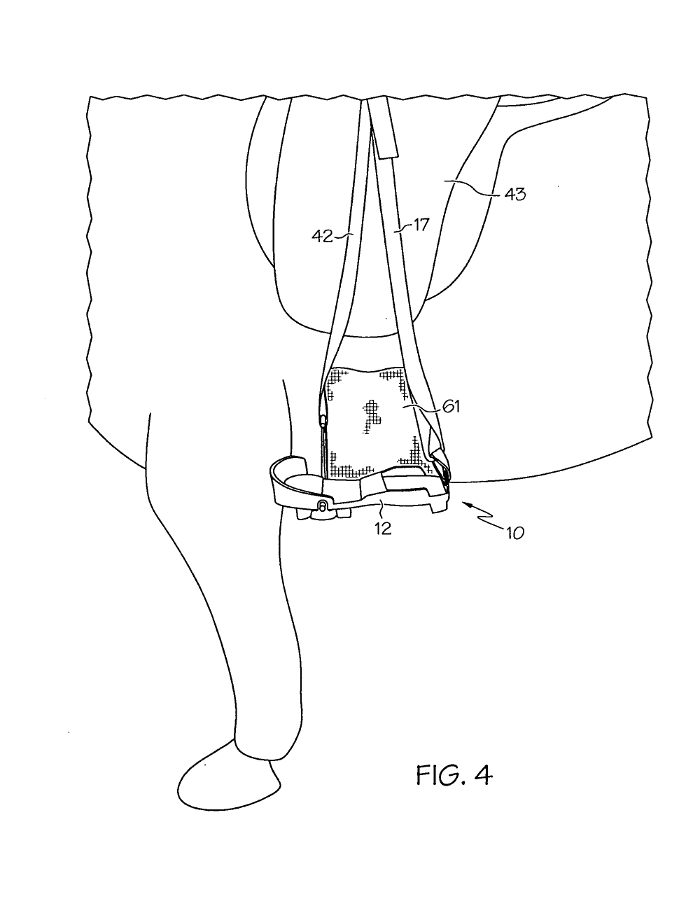

Referring generally to FIGS. 3 and 4, platform 12, forward arch 14, and rear support 15, and front foot guard 27 are preferably formed as a unitary piece. Preferably these elements are formed of a relatively rigid material, such as a light metal alloy, polymer, carbon fiber or other suitable material. Material can be removed so as to lighten the structure, such as holes being drilled in or otherwise removed from platform 12, forward arch 14, rear support 15, and/or front foot guard 27 so as to render the overall structure lighter than would be the case were the material still present. It will be appreciated that material should not be removed that would so weaken the structure so as to render the structure unsuitable as a support stirrup.

In a preferred embodiment, platform 12 is a generally planar structure. In operation, a rider's foot rests upon platform 12, and the flat, planar structure of platform 12 provides a flat support for the foot. However, in other embodiments, platform 12 need not take the planar structure. For example platform 12 may have a slight curvature. Alternatively, platform 12 may have a stepped structure where one portion of platform 12 is at a different elevation than another portion of platform 12. For example, that portion of platform which would provide a heel support may be raised or lowered, such ask for example heel recess 28, relative to that portion of platform 12 providing support for the ball of the foot. Accordingly, that portion of platform which would provide support to the toes may be raised or lowered such as, for example, toe ramp 29, relative to that portion of platform 12 providing support for the ball of the foot.

It will of course be appreciated that stirrup 10 and its components such as platform 12 need not come in only one size, but rather stirrup can be manufactured in different sizes, for example small, medium, and large sizes. Stirrup 10 may contain components such as, for example, a length sizing plate and/or a width sizing plate allowing adjustment in the size of length 25 and/or width 26. Thus, the dimensions of platform 12 can vary. It is preferred that length 25 of platform 12 be sufficient so as to provide a support for a rider's foot. Likewise the width 26 of platform 12 is preferably sufficient to accommodate the rider's foot. While platform 12 may have some front to back taper, or vice versa, it is generally preferred that little or no taper be present.

Forward arch 14 is attached to platform 12. Forward arch 14 may also be integral to the stirrup. As shown in FIG. 3 forward arch 14 is attached to inner edge 21, or that side of platform 12 which would be disposed next to the horse's barrel. In a preferred embodiment, forward arch 14 is a generally planar structure; however, other non-planar structures can be utilized. It is also generally preferred that forward arch 14 be positioned in a generally normal arrangement with respect to platform 12 where the ball of the foot rests although, again, other configurations are possible. The generally normal relationship between forward arch 14 and platform 12 is preferred so as to allow stirrup to best function in its intended purpose. In operation a rider's foot will fully rest on platform 12. The rider's ankle and leg will necessarily extend in a generally upward direction from platform 12. Where forward arch 14 is set at an approximate 90 degree angle relative to platform 12, forward arch 14 will present a minimum interference with the rider's leg. Further, by extending in an arrangement normal to platform 12, forward arch 14 will rub against the horse's barrel a minimal amount.

Rear support 15 may assume different configurations. In one embodiment it can attach to rear edge 24 and take a substantially planar, plate-like form. Such an embodiment is preferably set at a substantially right angle relative to rear edge 24 of platform 12, though other angular relationships are of course possible. Rear support 15 may also be integral to the stirrup at rear edge 24. Rear support can include the loop or plate through which a strap is attached as explained further herein as a separate or integral element. Side or lateral supports 63 can also be positioned proximate to rear support in order to help maintain the rider's heel in position.

In a preferred embodiment, stirrup 10 also includes one or more straps by which stirrup 10 is hung from a saddle. (Reference will be made to straps or stirrups hanging from a saddle; however, it should also be understood that the straps or stirrups may also hang from or be connected to other structures such as a pad.) Referring again to FIG. 3, a forward strap 42 is attached to forward arch 14. Preferably, forward strap 42 is connected to forward arch 14 generally at a mid point above width 26 of platform 12. In this manner of connection, forward strap 42 supports stirrup 10 at a balance point so as to minimize the tipping of stirrup 10 in either an inward or outward direction. Forward strap 42 is further connected to saddle 17 by methods known in the art such as, for example, saddle or strap buckles. Forward strap 42 can connect to forward arch 14 through a means known in the art such as looping through a hole or opening provided in forward arch 14 to receive forward strap 42. Forward strap 42 may also be integral to the stirrup. Structures or elements integral to or attached to forward arch 14 can also receive forward strap 42.

A rear strap 43 may also be used to suspend and stabilize stirrup 10 from saddle. In the embodiment illustrated in FIG. 3 one end of rear strap 43 is affixed to or looped through the rear support 15. Rear strap 43 may be affixed to either platform 12 or rear support 15, if present. While not illustrated, the other end of rear strap 43 would be affixed to the saddle in some manner known in the art. Just as forward strap 42 was shown to be attachable at various positions, so also rear strap 43 may also be affixed at various positions. For example, rear strap 43 may be affixed at a generally midpoint position. Rear strap 43 can connect to rear support 15 through a means known in the art such as looping through a hole or opening provided in rear support 15 or rear edge 24 to receive rear strap 43. Rear strap 43 may also be integral to the stirrup. Rear strap 43 may also include a Y structure. Rear strap 43 may contain an elastic component. This elastic element will serve to provide contact of stirrup 10 to the rider's foot during vertical movement of the rider's heel while riding at various gaits. Finally, multiple rear straps 43 may be used if desired.

It is generally desired that whatever straps are used to suspend stirrup 10 that they be selected and attached in a manner that allows platform 12 to rest in a generally horizontal configuration or a configuration slightly pitched from horizontal. In other words assuming a saddled horse with the platform stirrup attached to the saddle, with the horse standing in a normal position on flat ground, it is desired that platform 12 be configured so as to hang in a position generally parallel to the ground. As shown in FIG. 4, this horizontal—or slightly pitched—positioning of platform 12 also generally corresponds to the position that the rider's foot will assume when the rider is in the saddle. Thus, platform 12 will be properly aligned to rest under the rider's foot; and in this manner the rider can place both the right foot and the left foot on each platform. In such a position, stirrup 10 and platform 12 are positioned so as to receive the weight of the rider as the rider's feet press against platform 12.

One consideration in the placement of rear strap 43 relates to safety. Particularly, it is desired that rear strap 43 be configured so as to minimize the potential of a rider's foot becoming entangled. Thus, the embodiment in which rear strap 43 is affixed proximate to the midpoint of rear edge 24 of platform 12 is preferred as presenting a minimal risk of foot entanglement.

In a further embodiment, stirrup 10 may also include a shroud or shield with which to further minimize the risk of foot entanglement. For example as shown in FIGS. 3 and 4 shroud 61 is positioned so as to attach to inner edge 21 of platform 12. Shroud 61 extends upwardly from platform 12 and may further be attached or supported at an upper position to forward strap 42. There are other possible ways in which shroud 61 can be affixed to stirrup 10. For example, shroud 61 can be affixed to rear strap 43. Further, shroud 61 need not be attached to platform 12, but may be attached to front foot guard 27 and/or rear edge 24. However it is chosen to be attached, one purpose of shroud 61 is to act as a barrier against the inward movement of the rider's foot, so as to prevent the foot from slipping under rear strap 43 and/or forward strap 42. Thus, shroud 61 is preferably fabricated of a fabric material or leather. Further, it is preferred that shroud 61 be attached and configured so as to make a generally firm or taut presentation against the rider's foot as opposed to a loose or slack presentation. The generally taut configuration should be selected with a degree of firmness sufficient to inhibit the undesired slippage or inward movement of the rider's foot.

Preferably the inner rear corner of stirrup 10, the area proximate rear edge 24 of platform 12 is open and unobstructed, as shown in FIG. 3, other than for the presence of shrouds 61. The purpose for this unobstructed configuration is to allow the rear portion of a rider's foot to make contact with the horse's barrel. This is one reason why it is preferred to fabricate shroud 61 from a fabric material; the fabric material allows pressure communication from the rider's foot through the fabric and to the horse. Thus, the platform stirrup 10 allows the rider to control the horse using traditional foot taps, foot pressure, etc.; and the stirrup 10 does not significantly or substantially interfere with this kind of control.

A cushion, pad, non-slip material or texture (not shown) can be disposed on all or part of the top surface of the platform. The cushion or texture can act to provide a non-slip surface for the rider's foot.

Having described the improved riding stirrup from a structural and mechanical standpoint, a method of using the stirrup will now be described. This discussion will assume that the reader is familiar with the equestrian arts and is capable of saddling the horse. Referring next to FIG. 8, an improved riding stirrup can be used by hanging a pair of stirrups, left and right, from a saddle. Steps 81 and 82. The stirrups are hung by attaching straps to both the stirrups and the saddle. Straps may be forward straps and/or inner straps set in any of the configurations previously described. Preferably the stirrups are set so that platform 12 hangs generally horizontally as shown in FIGS. 3 and 4. Once the stirrups are securely set in place, the rider can mount the horse. Resting in the saddle, the rider places his or her left foot on the first platform stirrup, step 83. The rider also places his or her right foot on the second platform stirrup, step 84. (It will be appreciated that a rider can begin the mounting procedure with the opposite foot from that described herein.) The rider can now place weight on each of the feet. In doing so, the rider supports his or her weight by placing weight on both the balls and the heels of each foot, step 85; and the rider's weight may be simultaneously partially supported by sitting on the horse's back.

The improved stirrup provides support and balance to the rider that is different from that achieved with other stirrups and other riding styles. The rider now experiences a stability and security from the stirrup by supporting weight over a significant portion of the bottom of the foot. It is possible for the rider to place weight on both the ball and the heel of the foot simultaneously. The rigidity of the stirrup platform provides the rider an experience akin to standing on the ground. When the horse begins its motion the rider experiences an added balance with the feeling of stability that the feet communicate. The rider will particularly experience an advantageous sensation provided by the improved riding stirrup during horse gaits such as trotting and cantering. This manner of riding can be uncomfortable, and somewhat violent, to some riders, particularly beginning riders. The stability provided by the platform stirrup gives the rider comfort and stability with which the rider then gains the confidence to master those riding styles.

The discussion herein has focused on riding as practiced with respect to horses. However, it should be appreciated that the embodiments described herein may also be used and practiced with other types of animals, such as for example, camels, mules, donkeys, ostriches, and elephants.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

What is claimed is:

1. An improved stirrup for supporting a rider's foot at both the heel and toe, the rider resting on a saddle, the stirrup comprising:
a platform;
a forward strap affixed to the platform and attached to the saddle; and
a rear strap affixed to the platform and attached to the saddle.

2. The improved stirrup according to claim 1 wherein the platform is configured so as to support the heel and ball of the rider's foot.

3. The improved stirrup according to claim 1 further comprising a forward arch attached to the platform, and wherein the forward strap is affixed to the forward arch.

4. The improved stirrup according to claim 3 wherein the inner forward arch extends from the platform in a substantially right angle.

5. The improved stirrup according to claim 3 further comprising a rear support attached to the platform, and wherein the rear strap is affixed to the rear support.

6. The improved stirrup according to claim 5 wherein the platform is substantially planar.

7. The improved stirrup according to claim 6 wherein the forward strap and the rear strap are configured so as to hold the platform in a position substantially parallel to the ground.

8. The improved stirrup according to claim 7 further comprising a shroud affixed to the platform.

9. The improved stirrup according to claim 8 wherein the rider's heel contacts the horse's barrel through the shroud.

10. The improved stirrup according to claim 1 wherein the platform comprises a material selected from the group consisting of a metal alloy, polymer, or rigid material.

11. The improved stirrup according to claim 1 wherein the platform is characterized by having holes.

12. A platform stirrup for supporting an equestrian rider's foot comprising:
a substantially planar platform defining an inner edge and an outer edge, a front edge and a rear edge, a forward arch and a rear support, and wherein the platform is shaped so as to accommodate the rider's foot;
an front foot guard extending from the platform in a substantially right angle;
a forward strap affixed to the forward arch;
a rear strap affixed to the rear support of the platform;
wherein the forward strap and the rear strap are configured so as to position the platform substantially parallel to the ground;
a flexible shroud material affixed to the inner edge of the platform; and
wherein the flexible material allows the rider's heel to contact the barrel of the horse.

13. The platform stirrup according to claim 12 wherein the rear strap is affixed proximate the rear edge of the platform.

14. The platform stirrup according to claim 12 wherein the forward strap is affixed proximate the forward arch.

15. The platform stirrup according to claim 12 further comprising a front foot guard affixed to the platform.

16. The platform stirrup according to claim 15 wherein the front foot guard is affixed to the platform in a substantially right angle.

17. The platform stirrup according to claim 12 further comprising a pad or texture disposed on the to surface of the platform.

18. A method for supporting an equestrian rider in a saddle comprising the steps of:
hanging a first platform stirrup from the left side of a horse;
hanging a second platform stirrup from the right side of a horse;
placing the rider's left foot on the first platform stirrup such that both the ball and heel of the rider's left foot contact the platform; and
placing the rider's right foot on the second platform stirrup such that both the ball and heel of the rider's right foot contact the platform.

19. The method according to claim 18 further comprising the steps of:
supporting the first platform stirrup with a forward strap connected to the saddle;
supporting the first platform stirrup with a rear strap connected to the saddle;
supporting the second platform stirrup with a forward strap connected to the saddle; and
supporting the second platform stirrup with a rear strap connected to the saddle.

20. The method according to claim 18 wherein the rider has a left foot and a right foot that each includes a ball and a heel, the rider has a weight, and wherein the rider's weight is substantially supported on the right heel resting on the second platform and wherein the rider's weight is substantially supported on the left heel resting on the first platform.
